(19) United States
(12) Patent Application Publication
(10) Pub. No.: US 2025/0340053 A1
(43) Pub. Date: Nov. 6, 2025

(54) Method for Manufacturing Lamination Stacks from Stacked Laminations and Apparatus for Carrying Out Such Method

(71) Applicant: Feintool International Holding AG, Lyss (CH)

(72) Inventors: Björn Böker, Esslingen (DE); Oliver Hilligardt, Walheim (DE); Duncan Maina Kirigo, Eppingen (DE)

(73) Assignee: Feintool International Holding AG, Lyss (CH)

(21) Appl. No.: 19/196,931

(22) Filed: May 2, 2025

(30) Foreign Application Priority Data
May 5, 2024 (DE) 10 2024 001 492.6

(51) Int. Cl. B32B 37/12; B32B 38/00

(52) U.S. Cl. CPC B32B 37/12; B32B 2037/1253; B32B 38/0004

(57) ABSTRACT

The method is used to manufacture lamination stacks (3) out of laminations (2) lying on top of one another which are cut out of a starting material (1) and are joined to one another using a radiation-activatable adhesive (4) within the lamination stack (3). The adhesive (4) is irradiated with radiation with a wavelength range below IR radiation for pre-activation. The installation used for this purpose has at least one application device for applying the adhesive (4) to a lamination (2). The adhesive (4) is irradiated with at least one radiation source (32) which emits radiation in a wavelength range below the infrared range.

### CROSS-REFERENCE TO RELATED APPLICATION

This application claims the benefit of German Patent Application No. 10 2024 001 492.6, filed 2024 May 5, the contents of which is incorporated in its entirety.

### TECHNICAL FIELD

The disclosure relates to a method for manufacturing lamination stacks out of stacked laminations and an installation for carrying out such a method.

### BACKGROUND

When manufacturing lamination stacks, as are used for rotors or stators of electric motors or generators, it is known to cut the laminations out of an electrical strip or out of metal sheets which are laid on top of one another in order to form laminations stacks. The stacked laminations may be firmly connected to one another in different ways. One possible way of connecting them is to use an adhesive to connect together laminations sitting on top of one another. Use is made here of adhesives which are irradiated for activation after application. For this purpose, use is made of infrared radiation with which activation can easily be achieved, but which generates heat in the lamination made of metal. The consequence of this is an unwanted deformation of the lamination, which impairs the formation of the lamination stack. The heating of the lamination also results in undesirable electrical interference in the later use of the rotor or stator. Cooling systems are used to keep such undue deformations of the lamination as small as possible, but these increase expenditure on equipment.

### SUMMARY

An object underlying the disclosure is to configure the generic method and the generic installation so that the stacking of the laminations with the help of adhesive is ensured reliably and without adversely affecting electrical parameters during later use of the lamination stack.

This object is achieved in the method and in the installation as disclosed and claimed.

In the method for manufacturing lamination stacks out of laminations, use is made of an adhesive which can be pre-activated with radiation which lies in a wavelength range below the wavelength range of IR radiation. No heat that would lead to warping or deformation of the laminations is therefore produced when the adhesive is activated. Therefore, when carrying out the method, no cooling of the lamination or the lamination stack is necessary either, so the installation used for this purpose is simple to set up and inexpensive to purchase.

The reaction time of this adhesive is so short that the adhesive can react as soon as the next lamination is placed on top of the stack so that the stacked laminations are sufficiently firmly connected to one other. This firmness is sufficient to handle the lamination stack formed in each case immediately after completion, in particular to transport the lamination stack to the customer, without the risk of the lamination stack falling apart.

An advantageous wavelength range of the radiation lies in a range between approximately 300 nm and approximately 700 nm. The adhesive can be optimally pre-activated in this wavelength range.

In the method, the adhesive is pre-activated so that the lamination stack formed is handleable. For the manufacturer of the lamination stack, this has the advantage that it can send the lamination stacks to the customer immediately after the stack has been formed, for example, and does not have to wait until the adhesive has achieved sufficient stack strength.

A cationically curing epoxy resin adhesive has proven to be a particularly advantageous adhesive.

The method is advantageously designed so that the adhesive cures after pre-activation and during and also after the lamination stack formation so that the lamination stack has the stack strength required for the later application.

A particularly simple method is used if the radiation is directed so that it is directed onto the adhesive located on the lamination or the starting material. The adhesive can then be pre-activated without any problems.

In a simple method, the radiation falls perpendicularly onto the lamination or the starting material. Depending on the extent of the adhesive, the irradiation of the adhesive located on the lamination or the starting material can be either flat or point-like or spot-like.

In another advantageous embodiment, the radiation is directed so that it does not fall perpendicularly onto the lamination or the starting material, but at an angle other than 90°. This can be advantageous, for example, if the installation conditions do not allow the installation of a radiation source vertically above the lamination or the starting material.

In a further embodiment, the adhesive is already irradiated before application to the lamination or the starting material during the discharge from the application device to the lamination or to the starting material while in mid-air. When the adhesive falls onto the lamination or the starting material, it is already pre-activated. This procedure enables particularly simple and reliable lamination stack formation.

In this method, the radiation is advantageously directed perpendicularly to the fall path of the adhesive.

The adhesive can be applied to the lamination or the starting material in the form of drops or as an adhesive film. Accordingly, the radiation is designed in such a way that the adhesive is perfectly irradiated while in mid-air.

It is also possible to apply the adhesive to the lamination or the starting material using an application roller. In this case, the application roller is in contact with the lamination or the starting material.

The application roller is advantageously designed to apply an adhesive pattern to the lamination or the starting material. The adhesive pattern is adapted to the shape of the lamination to be produced, so that the adhesive is located in the required position after the lamination has been cut out.

The installation for manufacturing lamination stacks out of laminations is characterized in that it has at least one radiation source that emits radiation in a wavelength range below the infrared wavelength range.

The wavelength range advantageously lies in a range between approximately 300 nm and approximately 700 nm.

The radiation source is advantageously arranged in the installation so that the radiation emitted by it affects the adhesive located on the lamination or on the starting material. The adhesive can therefore first be applied to the lamination or the starting material and then irradiated for pre-activation.

In a further embodiment, the installation is designed so that the radiation from the radiation source strikes the adhesive as it falls from the application device towards the lamination.

Such a configuration is particularly advantageous when the adhesive is applied only in the region of separation of the lamination.

To ensure that proper pre-activation of the adhesive with such an arrangement of the radiation source is achieved particularly reliably, it is advantageous if an aperture is located in the beam path of the radiation source, the opening of which is preferably adjustable in terms of its cross-section. The radiation can then be adjusted regardless of whether the adhesive is applied in droplet form, stripe form or the like.

It is also possible to design the application device as an application roller that can rotate around its axis and has at least one dispensing opening for the adhesive in its casing. For adhesive application, the application roller rests against the lamination or the starting material, with the adhesive being applied via the dispensing opening. The position of the dispensing opening and the diameter of the application roller are selected so that the adhesive emerging from the dispensing opening is applied to the lamination or starting material at the position required for subsequent stack formation.

The dispensing opening is advantageously configured in the form of a sieve. The adhesive can then be applied to the lamination or starting material through the sieve openings. In particular, the sieve-like design allows an adhesive pattern to be applied easily to the lamination or starting material.

To ensure clean adhesive application, a cleaning roller is advantageously attached to the application roller, the cleaning roller being arranged axially parallel to the dispensing roller and being used to keep the roller surface free of adhering adhesive. This makes it easy to ensure that the adhesive only reaches the lamination or starting material in the region where the dispensing opening is located.

### BRIEF DESCRIPTION OF THE DRAWINGS

The invention is explained in more detail below using several embodiments illustrated in the drawings. In the figures:

FIG. 1 shows a schematic representation of an installation for applying a radiation-activatable adhesive to an electrical strip from which laminations are punched or cut.

FIG. 2 shows an enlarged plan view of an application roller of the installation according to FIG. 1.

FIG. 3 shows the development of the casing surface of the application roller according to FIG. 2 in the plane of the drawing.

FIG. 4 shows an enlarged view of part of a lamination with a geometry-specific bond.

FIG. 5 shows a simplified view of an adhesive application device for manufacturing lamination stacks out of laminations.

FIGS. 6 to 10 show, in views corresponding to FIG. 5, further embodiments of adhesive application devices for manufacturing lamination stacks out of laminations.

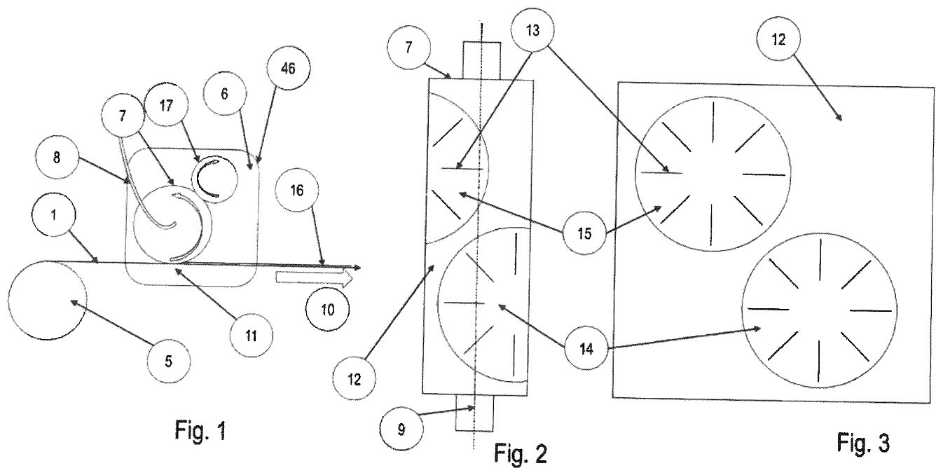

### DETAILED DESCRIPTION

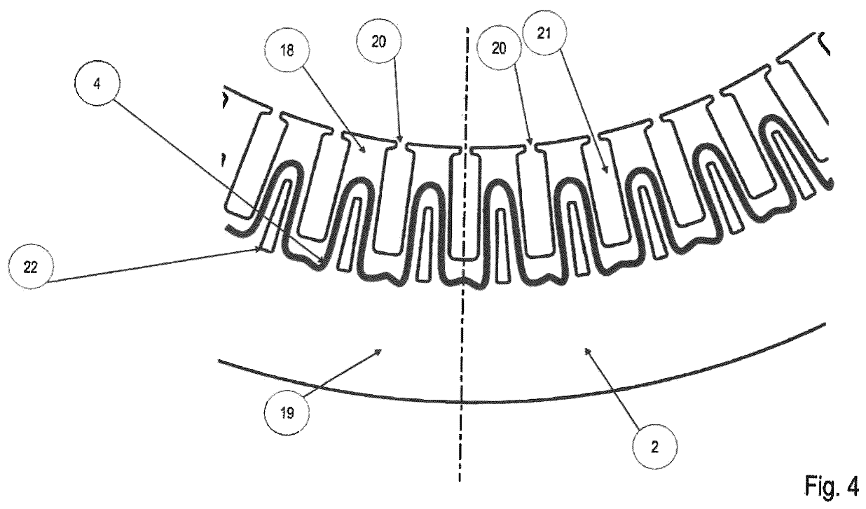

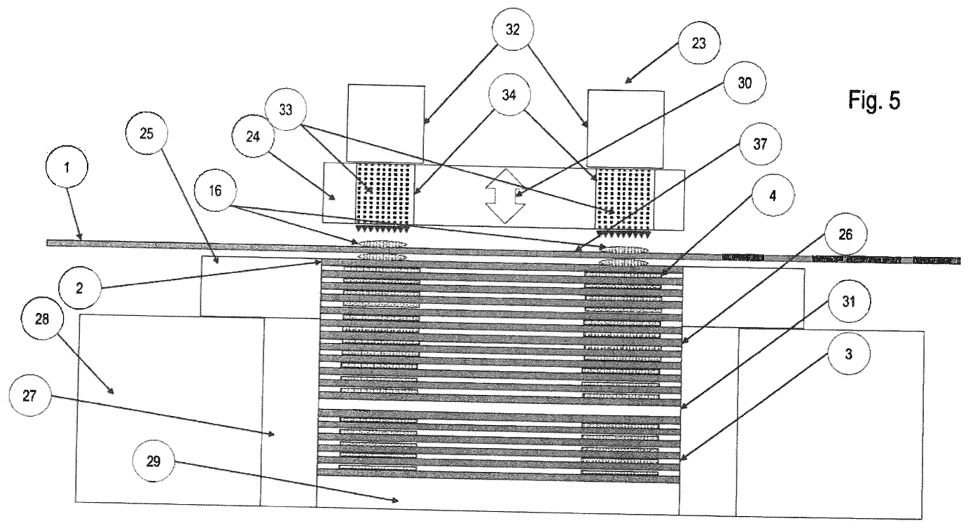

Using the installations and devices described below, laminations 2 (FIGS. 4 and 5) are separated from an electrical strip 1 and stacked to form lamination stacks 3 (FIG. 5). These lamination stacks are used for rotors or stators of electric motors or generators.

Within the lamination stack 3, the laminations 2 lying on top of one another are firmly connected to one another by means of an adhesive 4.

The laminations 2 can be separated from the electrical strip 1 by various methods, for example by punching, water jet cutting, laser cutting and the like.

The electrical strip 1 is wound as a coil onto a reel 5 (FIG. 1), from which the electrical strip 1 is unwound in a known manner and fed to a separation station, where the laminations 2 are separated from the electrical strip 1.

At least one adhesive application device 6 (hereinafter referred to as the application device) is arranged in the feed path to this separation station. It is used to apply the adhesive 4 to the electrical strip 1.

The adhesive 4 is applied by at least one application roller 7, to which the adhesive 4 is fed via at least one adhesive feed line 8.

The application roller 7 is rotatably driven around its axis 9 during adhesive application. As can be seen from FIG. 1, in this example the application roller 7 rotates anticlockwise during adhesive application. The electrical strip 1 is transported in the transport direction 10. In the application region of the adhesive 4, the application roller 7 and the electrical strip 1 thus have the same direction of movement.

On the roller casing 12 there is at least one sieve-shaped dispensing opening 13 (hereinafter referred to as the sieve), which is a negative form of the adhesive geometry to be applied to the electrical strip 1.

In the illustrated exemplary embodiment, two such sieves 13 are mounted on the roller casing 12, these being arranged offset from one another in the circumferential direction of the application roller 7 and spaced apart from one another.

The lower sieve 13 in FIG. 3 lies in a tool track 14, and the upper sieve 13 in a tool track 15. The two tool tracks 14, 15 correspond to the tool tracks of the electrical strip 1. The laminations 2 are separated from the electrical strip 1 in two tracks using the corresponding tools, with the tool tracks of the separating device corresponding to the tool tracks 14, 15 of the application roller 7.

The sieves 13 produce an adhesive pattern on the lamination 2 or the electrical strip 1, which is adapted to the shape of the lamination 2 to be produced.

The adhesive 4 is fed to the application roller 7 via the adhesive line 8. The adhesive 4 is advantageously fed along the axis of the application roller 7, which has inside it corresponding supply lines to the sieves 13 on the roller casing 12. The adhesive 4 can pass through the sieve 13 onto the upper side of the electrical strip 1. Depending on the geometry of the sieve 13, a corresponding geometry of the adhesive application 16 is created on the upper side of the electrical strip 1.

The application roller 7 is housed in a housing 46 containing a protective gas, such as nitrogen, which prevents the ingress of oxygen. The adhesive 4 can thus be pre-activated at any time.

To ensure clean adhesive application to the electrical strip 1, the application device 6 has at least one cleaning roller 17 which rests against the application roller 7 and has a smaller diameter than the latter. The cleaning roller 17 can be driven rotatably, but can also be rotated around its axis by its contact with the rotatably driven application roller 7. The two rollers 7, 17 rotate in opposite directions. The cleaning roller 17 advantageously rests against the application roller 7 with low pressure.

The axially parallel positioning of the cleaning roller 17 with respect to the application roller 7 ensures that the upper surface of the application roller 7 is always free of contaminants, thus ensuring clean application of the adhesive onto the electrical strip 1.

Depending on the design of the sieve 13, the adhesive 4 can be applied to the electrical strip 1 over a large area, or in a linear or dotted manner.

FIG. 4 shows the possibility of applying the adhesive 4 to the electrical strip 1 in a linear manner, for example.

In the illustrated exemplary embodiment, the lamination 2 separated from the electrical strip 1 has radially extending arms 18 that project inwards from an annular base body 19 and are spaced apart from one another. The free ends of the arms 18 are widened in both circumferential directions, with the widened portions of adjacent arms 18 each delimiting an insertion opening 20.

Between the arms 18 are grooves 21 for receiving wire windings (not shown).

The arms 18 are also each provided with a radially extending cooling groove 22, which extends, for example, into the base body 19. The cooling grooves are located halfway across the arms 18.

The adhesive 4 is now applied to the lamination 2 such that it surrounds the cooling grooves 22 at a distance. The adhesive 4 is guided between adjacent cooling grooves 22 via the annular base body 19 between the arms 18.

In this way, a continuous adhesive rod can be applied over the circumference of the annular lamination 2, via which laminations 2 located on top of one another within the lamination stack 3 can be firmly connected to one another.

The lamination stack 3 can be formed from annular laminations 2, which are separated from the electrical strip 1 as rings. For larger diameters of the lamination stack 3, partially annular laminations are separated from the electrical strip 1 and then assembled to form a lamination ring.

The adhesive 4 used can be activated by radiation. For adhesive activation, radiation with a wavelength in the range between approximately 300 nm and approximately 700 nm is used. This radiation range lies below the infrared radiation range. The adhesive 4 is preferably a cationically curing epoxy resin adhesive.

When the adhesive 4 is activated with radiation corresponding to the specified wavelength range, the adhesive 4 is pre-activated. Due to this pre-activation, the adhesive 4 has such a bonding strength that the laminations 2 lying on top of one another in the lamination stack 3 are firmly bonded to one another, so the lamination stack 3 can be handled immediately. The adhesive 4 is fully cured later at room temperature.

During pre-activation and curing, no or at most only slight heating occurs, so the laminations 2 do not exhibit any warping that could lead to technical problems during later use of the lamination stack 3. Since no or only slight heat is generated during pre-activation and curing of the adhesive 4, no cooling of the laminations 2 or the lamination stack 3 is required.

After pre-activation, complete curing takes place without additional radiation exposure. This is known as shadow curing.

The cationically curing epoxy resin adhesive is electrically insulating and voltage-equalizing. It can be used over a wide temperature range, from approximately −40° C. to approximately 150° C. and above.

The pre-activation time is typically only a few seconds. This pre-activation time is sufficiently short to form the lamination stack 3 from the laminations 2 which lie on top of one another and are bonded together.

The adhesive 4 is applied to the laminations 2 where it is required for the cohesion and firmness of the lamination stack 3.

The sieves 13 are accordingly positioned on the roller casing 12 of the application roller 7, ensuring that the adhesive application 16 provided at the desired location on the electrical strip 1. After the adhesive has been applied, the laminations 2 are separated from the electrical strip 1, with the adhesive application 16 already provided at the required location on the laminations 2 to be punched out.

FIG. 5 shows a punching unit 23 of the installation for punching the laminations 2 from the electrical strip 1. The punching unit 23 has a pressure stamp 24 which interacts with a die 25 during the punching process. The laminations 2 are punched from the electrical strip 1 with the pressure stamp 24 and pressed into a shaft 26 in which the lamination stack 3 is produced. The die 25 is part of a lower tool 28 in which the shaft 26 is provided. It is limited in the region below the die 25 by a stack brake 27 which holds the lamination stack 3 to be formed in the shaft 26. The stack brake 26 rests on the circumference of the lamination stack 3 and prevents the lamination stack 3 from falling downwards.

It is also possible to provide a stamp (not shown) in the shaft 26, onto which the first lamination 2 of the lamination stack 3 is deposited. With each additional lamination 2, the stamp is gradually adjusted downwards accordingly. In this way, the lamination stack 3 can be stacked on the stamp at the required height.

As soon as the lamination stack 3 has reached the required height in the shaft 26, the lamination stack 3 is guided out of the shaft 26 by a stack discharge 29.

Since the design of the punching unit 23 is generally known, it is not described in detail.

When the lamination 2 is placed onto the laminations already located in the shaft 26, pressure is exerted by the pressure stamp 24, which causes the adhesive application 16 to be compressed. As FIG. 5 shows, the pressure application forces the adhesive application 16 apart, thereby correspondingly increasing the contact area between the laminations 2 lying on top of one another.

The stack brake 27 is designed such that the braking force it exerts on the lamination stack 3 is greater than the pressure force exerted by the pressure stamp 24.

During the punching process, the pressure stamp 24 moves vertically in the direction of the arrow 30.

In order to separate lamination stacks 3 following one another in the shaft 26 from one another, no adhesive is applied to the last lamination 2 of the lamination stack 3. This creates a separation 31 between the superimposed lamination stacks 3.

To activate the adhesive, the punching unit 23 is provided with at least one UV light source 32 which emits UV light 33 to activate the adhesive application 16. The UV light source 32 is designed so that the radiation 33 emitted by it strikes the adhesive application 16 parallel to the punching movement direction 30.

The UV light source 32 is designed so that the adhesive application 16 can be irradiated over its entire area. For example, the UV light source 32 has spotlights arranged side by side and one behind the other. The light beam 33 emerging from the UV light source 32 can be designed depending on the shape of the adhesive application 16. If the adhesive application 16 is circular, for example, the UV light 33 can, for example, be designed as a spotlight.

The pressure stamp 24 is provided with a corresponding recess 34 for the passage of the UV light 33, through which the light can reach the adhesive application 16. The UV light source 32 is advantageously arranged outside the pressure stamp 24.

The UV light emitted by the UV light source 32 lies within the wavelength range specified above, to which the adhesive 4 is set for pre-activation.

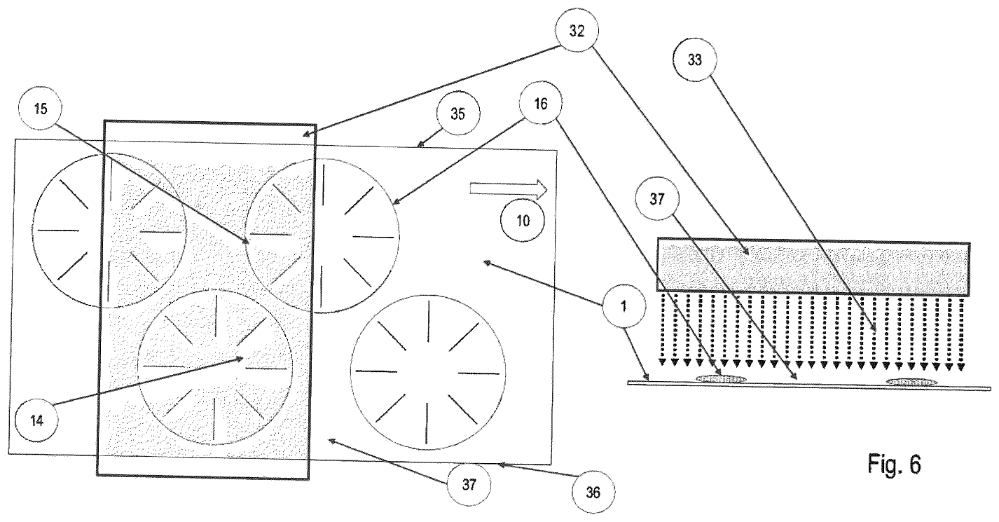

FIG. 6 shows the possibility of activating the adhesive application 16 by means of a planar UV light 33. The adhesive applications 16 are located on the electrical strip 1 and are arranged in the two tracks 14, 15 in the manner described.

The UV light source 32 is designed as a surface lamp that extends transversely to the transport direction 10 of the electrical strip 1. The UV light source 32 extends beyond the two longitudinal edges 35, 36 of the electrical strip 1.

As in the previous exemplary embodiment, the UV light source 32 is located at a distance above the electrical strip 1 and thus the adhesive application 16. As in the previous embodiment, the UV light 33 strikes the electrical strip 1 perpendicularly and causes the pre-activation of the adhesive application 16.

The electrical strip 1 has regions 37 between the adhesive applications 16 that have no adhesive.

In the exemplary embodiment, the UV light source 32 has a rectangular outline and radiates the UV light 33 across its entire cross-sectional width downwards towards the adhesive application 16. The UV light 33 strikes the adhesive application of both tool tracks 14 and 15. This enables pre-activation of the adhesive in both tool tracks 14, 15 in one pass of the electrical strip 1.

The UV light source 32 is arranged in a fixed position, relative to the transport direction 10 of the electrical strip 1, in accordance with the previous embodiment.

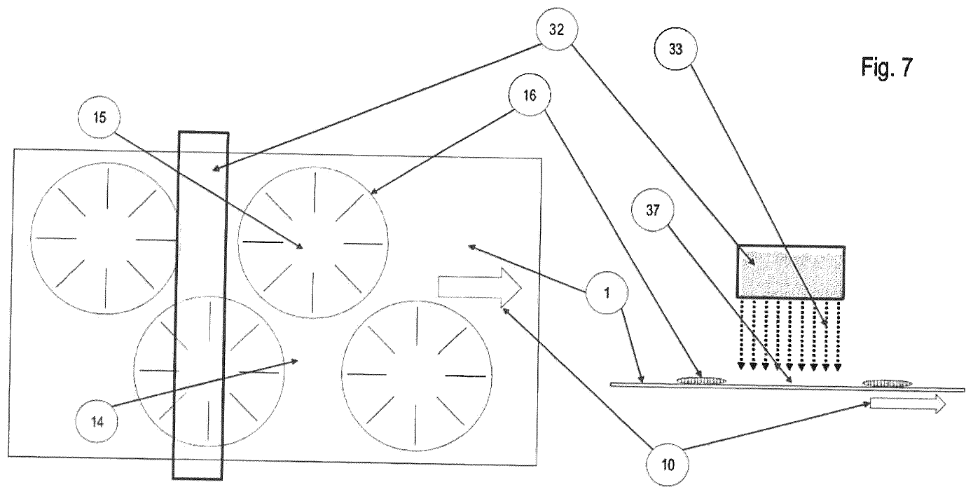

FIG. 7 shows a similar design of the UV light source 32 to FIG. 6. The only difference is that the UV light source 32 is narrower than in the exemplary embodiment according to FIG. 6. The irradiation of the surface by means of the UV light 33 is thus narrower than in the previous exemplary embodiment.

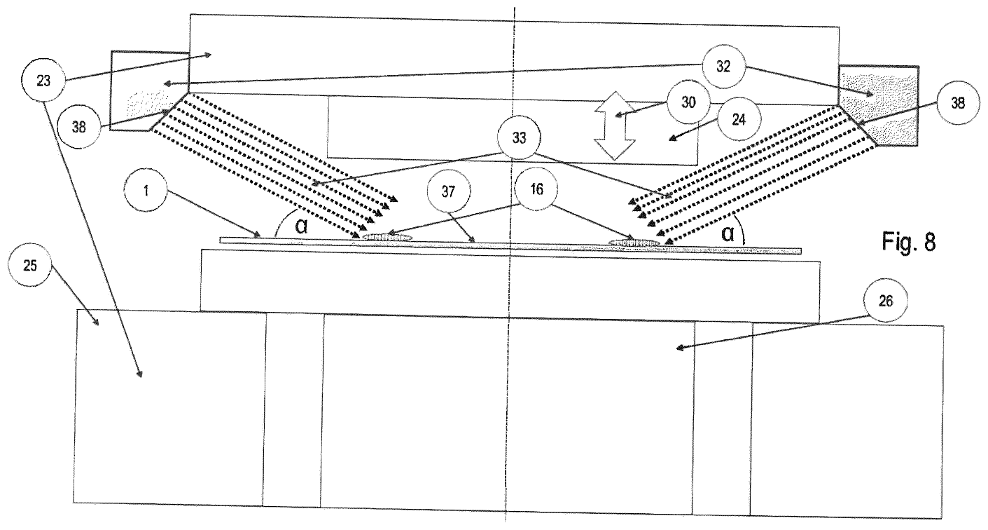

In the embodiment according to FIG. 8, the UV light 33 is not directed perpendicularly to the upper side of the electrical strip 1, but at an angle to it. The UV light 33 is directed at an acute angle α to the electrical strip 1 and accordingly strikes the adhesive in the respective adhesive application 16 at an angle. The angle of inclination α of the UV light 33 is selected so that the respective adhesive application 16 can be activated properly.

The UV light source 32 has inclined exit windows 38 through which the UV light 33 exits at an angle of inclination α.

The UV light source 32 is designed so that the radiation emerging from it strikes the respective adhesive application 16.

FIG. 8 shows the punching unit 23 with the pressure stamp 24 and the die 25. The pressure stamp 24 is actuated in the direction of the arrow 30 during the punching process to punch the laminations 2 out of the electrical strip 1. They are pressed by the pressure stamp 24 into the shaft 26 in the manner described, in which the laminations 2 are formed into the lamination stack 3.

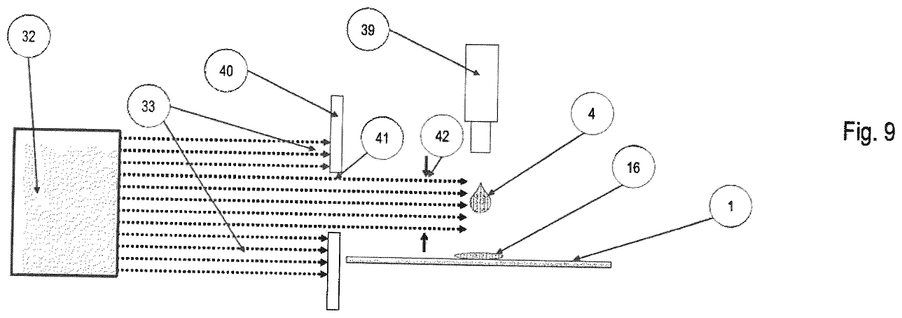

In the embodiment according to FIG. 9, the UV light 33 extends parallel to the electrical strip 1. The UV light 33 emerges from the UV light source 32.

The UV light 33 extends perpendicularly to the transport direction of the electrical strip 1. In FIG. 9, the transport direction is perpendicular to the plane of the drawing.

In contrast to the previous embodiments, it is not the adhesive application 16 on the lamination 2 or the electrical strip 1 that is irradiated with the UV light, but rather the adhesive 4 emerging from an application device 39. The application device 39 is advantageously a valve device with which the adhesive 4 falls downwards onto the electrical strip 1 in droplet form. While the droplet is in mid-air, the adhesive 4 is irradiated by the UV light 33. When the adhesive droplet falls onto the electrical strip 1 and forms the adhesive application 16 there, it is already pre-activated by the UV light 33.

Advantageously, an umbrella-like aperture 40 is located in the region between the UV light source 32 and the application device 39, ensuring that the UV light 33 specifically strikes the adhesive droplets emerging from the application device 34. It is advantageous if the opening cross section of the aperture 41 is adjustable so that reliable pre-activation of the respective adhesive 4 is guaranteed depending on the type of adhesive 4 and/or the UV light source 32 or the UV light used.

Advantageously, the installation is provided with several application devices 39 via which the adhesive 4 is applied to the electrical strip 1 at the required locations. The UV light source 32 is designed to pre-activate the adhesive droplets emerging from the various application devices 39.

The application device 39 is arranged at a distance above the electrical strip 1 such that the emerging adhesive droplets can be irradiated with the UV light 33 for a sufficiently long time. For this purpose, it is advantageous if the aperture 41 is adjustable in size. The beam region of the UV light 33 passing through the aperture 41 towards the adhesive droplet 4 can then be adjusted accordingly in terms of its width as measured perpendicularly to the electrical strip 1. Accordingly, the width 42 of the portion of the UV light 33 passing through the aperture 41 can be correspondingly adjusted.

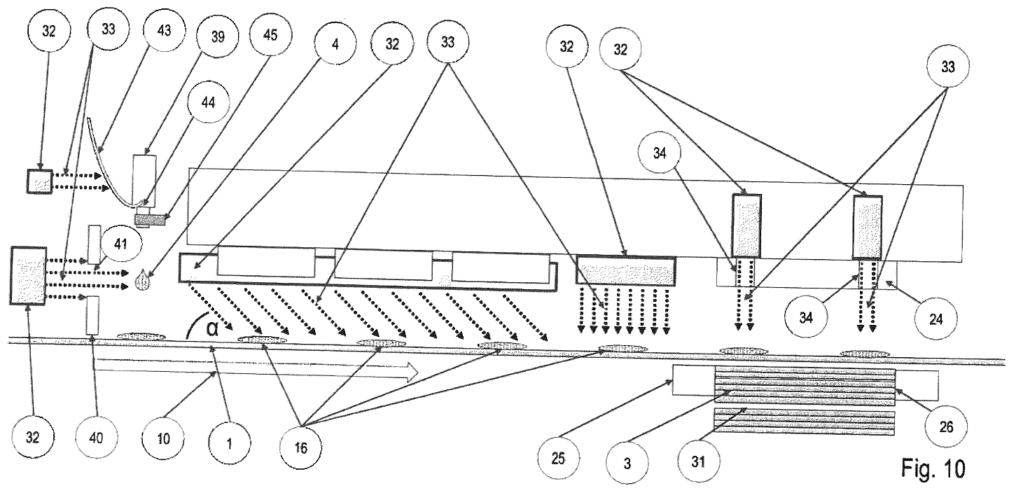

FIG. 10 shows the possibility of providing different types of irradiation in the installation.

A device is initially provided in the transport direction 10 of the electrical strip 1, as explained with reference to FIG. 9. The adhesive droplets 4 falling downwards from the application device 39 are pre-activated by irradiation with the UV light 33 which passes through the opening 41 of the aperture 40 parallel to the top of the electrical strip 1. The adhesive droplets 4 form the respective adhesive application 16 on the electrical strip 1.

Downstream in the transport direction 10 is the UV light source 32, which, according to FIG. 8, is configured so that the UV light 33 reaches the upper side of the electrical strip 1 or the respective adhesive application 16 at an angle α. This UV light source 32 is advantageously configured to continuously emit the UV light 33.

Behind this UV light source 32 in the transport direction 10, an arrangement as shown in FIG. 7 is provided, this arrangement being narrower transversely to the transport direction 10 than the preceding UV light source 32 with the obliquely exiting UV light 33.

A UV light source 32 corresponding to the embodiment according to FIG. 5 is provided in the region of the shaft 26 for forming the lamination stack 3. The UV light 33 radiates downwards through the recesses 34 in the pressure stamp 24 onto the electrical strip 1 or onto the respective adhesive application 16 located thereon.

FIG. 10 further shows the possibility of irradiating the adhesive 4 with UV light 33 already in a supply line 43 to the application device 39.

Advantageously, the application device 39 is surrounded by a heating element 45 at its adhesive outlet 44, which can ensure that the adhesive 4 falls smoothly downwards onto the electrical strip 1 in droplet form.

The installation according to FIG. 10 is only to be seen as an example of how different types of irradiation units can be used in combination with one another. Which irradiation units are used depends on the respective application of the installation. Thus, the various UV light sources 32 can be used if the type of adhesive 4 requires it to achieve sufficient pre-activation.

In all of the possibilities described, the laminations 2 are not heated by the adhesive 4, or only heated to such an extent no warping or stresses in the laminations 2 occur. The rotor or stator stack manufactured from the lamination stack 3 therefore exhibits good electrical properties. This is due to the fact that a wavelength range of the light source is used for irradiation which is smaller than the wavelength range intended for IR irradiation.

In the embodiment according to FIG. 9, the adhesive 4 can be applied to the electrical strip 1 not only in droplet form, one after the other. The application device 39 can also be designed so that the adhesive emerges from the application device 39, for example, in the form of an adhesive haze. The UV light source 32 is designed here so that the radiation emitted by it completely captures and pre-activates the adhesive haze. In this case, the UV light 33 advantageously runs perpendicularly to the adhesive haze so that it is perfectly irradiated and thus pre-activated.

1.-19. (canceled)

20. A method for manufacturing a lamination stack (3), comprising:
cutting out laminations (2) lying on top of one another of a starting material (1) and joining the laminations (2) to one another using an adhesive (4) within the lamination stack (3), wherein the adhesive (4) is radiation-activatable; and
irradiating the adhesive (4) with radiation having a wavelength range below IR radiation for pre-activation.

21. The method according to claim 20,
wherein the wavelength range of the radiation lies in a range between 300 nm and 700 nm.

22. The method according to claim 20,
wherein the adhesive (4) is activated through irradiation so that the laminations (2) are firmly connected to one another in the lamination stack (3).

23. The method according to claim 20,
wherein the adhesive (4) is a cationically curing epoxy resin adhesive.

24. The method according to claim 20,
wherein the adhesive (4) is cured within the lamination stack (3) so that the lamination stack (3) has a required stack strength.

25. The method according to claim 20,
wherein the radiation (33) is directed at the adhesive (4) located on the lamination (2).

26. The method according to claim 20,
wherein the radiation (33) falls perpendicularly onto the lamination (2) or the starting material (1).

27. The method according to claim 20,
wherein the radiation (33) falls onto the lamination (2) or the starting material (1) at an angle (a) other than 90°.

28. The method, according to claim 20,
wherein the adhesive (4) is irradiated while being applied by an application device (39) onto the lamination (2) or the starting material (1) while in mid-air.

29. The method according to claim 20,
wherein the adhesive (4) is applied by an application roller (7).

30. The method according to claim 29,
wherein an adhesive sample is applied with the application roller (7).

31. An installation for manufacturing lamination stacks (3), comprising:
an application device (7, 39) for applying an adhesive (4) to a lamination (2) which is irradiated with a radiation source (32),
wherein the radiation source (32) emits radiation in a wavelength range below the infrared range.

32. The installation according to claim 31,
wherein the wavelength range lies between 300 nm and 700 nm.

33. The installation according to claim 31,
wherein radiation (33) from the radiation source (32) is directed at the adhesive (4) located on the lamination (2) or on a starting material (1).

34. The installation according to claim 31,
wherein radiation (33) from the radiation source (32) is directed so that the radiation (33) strikes the adhesive (4) while it is falling from the application device (39) onto the lamination (2).

35. The installation according to claim 34, further comprising
an aperture (40) having an opening (41) with an adjustable cross-section arranged in a beam path from the radiation source (32).

36. The installation according to claim 31,
wherein the application device (7) is an application roller rotatable about an axis,
wherein the application roller has a casing (12) with at least one application opening (13) for the adhesive (4).

37. The installation according to claim 36,
wherein the application opening (13) is configured as a sieve.

38. The installation according to claim 36,
wherein a cleaning roller (17) arranged axially parallel to the application roller (7) lies thereon.
